(19) United States
(12) Patent Application Publication
(10) Pub. No.: US 2022/0207401 A1
(43) Pub. Date: Jun. 30, 2022

(54) OPTIMIZATION DEVICE, OPTIMIZATION METHOD, AND PROGRAM

(71) Applicant: NIPPON TELEGRAPH AND TELEPHONE CORPORATION, Tokyo (JP)

(72) Inventors: Hidetaka ITO, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/605,663

(22) PCT Filed: Apr. 20, 2020
(86) PCT No.: PCT/JP2020/017067

§ 371 Date: Oct. 22, 2021

(30) Foreign Application Priority Data
Apr. 24, 2019 (JP) 2019-083042

(51) Int. Cl. G06N 7/00; G06K 9/62

(52) U.S. Cl. CPC G06N 7/005; G06K 9/6262

(57) ABSTRACT

A plurality of parameter values can be simultaneously selected to achieve faster optimization of the parameters.

An optimization apparatus 10 includes: an evaluation unit 120 configured to perform calculation based on evaluation data and parameter values to be evaluated and output evaluation values representing evaluation of calculation results; a selection unit 100 configured to train a model for predicting the evaluation values for the parameter values based on the evaluation values output at the evaluation unit 120 and a combination of the parameter values and determine, based on the trained model, a plurality of the parameter values to be next evaluated at the evaluation unit 120; and an output unit 160 configured to output an optimized parameter value obtained by repeating processing at the evaluation unit 120 and determination at the selection unit 100. The evaluation unit 120 of the optimization apparatus 10 performs calculation based on the evaluation data and the parameter values and outputs the evaluation values, in parallel for each of the plurality of the parameter values determined at the selection unit 100.

### TECHNICAL FIELD

The present disclosure relates to an optimization apparatus, an optimization method, and a program.

### BACKGROUND ART

In various simulations such as human behavior or weather, there are parameters that are not automatically determined and should be manually specified in advance. Similar parameters are also seen in machine learning, robotic control, or experimental planning, and Bayesian optimization that is a technology for automatically optimizing those parameters has been proposed (Non Patent Literature 1). In the Bayesian optimization, an evaluation value of some kind is prepared, and a parameter is adjusted such that the evaluation value is maximized or minimized.

### CITATION LIST

### Non Patent Literature

Non Patent Literature 1: Shahriari, B., Swersky, K., Wang, Z., Adams, R. P. and Freitas, de N.: Taking the Human Out of the Loop: A Review of Bayesian Optimization, Proceedings of the IEEE, Vol. 104, No. 1, pp. 148-175 (2016).

### SUMMARY OF THE INVENTION

### Technical Problem

The present disclosure is directed to Bayesian optimization. The Bayesian optimization repeats two operations: selection of a parameter and acquisition of an evaluation value for the parameter. Of these operations, evaluation values for a plurality of parameters can be acquired in parallel by using a multi-core CPU or a plurality of GPUs. In the Bayesian optimization, however, a plurality of parameter values cannot be simultaneously selected, so that the parallel processing cannot be effectively utilized. Thus, there is a need for a technique to simultaneously select a plurality of parameter values.

The present disclosure has been made in light of the foregoing, and an object of the present disclosure is to provide an optimization apparatus, an optimization method, and a program that can simultaneously select a plurality of parameter values to achieve faster optimization of the parameters.

### Means for Solving the Problem

In order to achieve the object described above, an optimization apparatus of a first aspect of the present disclosure includes: an evaluation unit configured to perform calculation based on evaluation data and parameter values to be evaluated and output evaluation values representing evaluation of calculation results; a selection unit configured to train a model for predicting the evaluation values for the parameter values based on the evaluation values output at the evaluation unit and a combination of the parameter values and determine, based on the trained model, a plurality of the parameter values to be next evaluated at the evaluation unit; and an output unit configured to output the parameter value optimized obtained by repeating processing at the evaluation unit and determination at the selection unit, in which for each of the plurality of the parameter values determined at the selection unit, the evaluation unit performs calculation based on the evaluation data and the parameter values and outputs the evaluation values, in parallel.

An optimization apparatus of a second aspect of the present disclosure is the optimization apparatus according to the first aspect, in which the selection unit: trains the model based on the evaluation values output at the evaluation unit and a combination of the parameter values; using an acquisition function, with a parameter value determined by a prescribed method as an initial value, repeats obtaining a parameter value that takes a local maximum value of the acquisition function using a gradient method a plurality of times, the acquisition function being a function using an average and a variance of predicted values of the evaluation values obtained from the trained model; and selects a plurality of parameter values having a large value of the acquisition function among parameter values that take a local maximum value of the acquisition function to determine a plurality of the parameter values to be next evaluated at the evaluation unit.

An optimization apparatus of a third aspect of the present disclosure is the optimization apparatus according to the second aspect, in which the parameter includes a plurality of elements, and the selection unit: trains the model for a part of the elements, and using the acquisition function obtained from the model, repeats obtaining values of the part of the elements that take a local maximum value of the acquisition function a plurality of times; trains the model for another part of the elements, and using the acquisition function obtained from the model, repeats obtaining values of the other part of the elements that take a local maximum value of the acquisition function a plurality of times; and from the parameter values obtained by combining values of the part of the elements obtained a plurality of times and values of the other part of the elements obtained a plurality of times, determines a plurality of the parameter values to be next evaluated at the evaluation unit.

An optimization apparatus according to a fourth aspect of the present disclosure is the optimization apparatus according to any one of the first to third aspects, in which the evaluation unit performs the calculation using at least one calculation apparatus and outputs evaluation values representing evaluation of calculation results, in parallel.

An optimization apparatus of a fifth aspect of the present disclosure is the optimization apparatus according to any one of the first to fourth aspects, in which the model is a probability model using a Gaussian process.

In order to achieve the object described above, an optimization method of a sixth aspect of the present disclosure includes: performing, at an evaluation unit, calculation based on evaluation data and parameter values to be evaluated, and outputting evaluation values representing evaluation of calculation results; training, at a selection unit, a model for predicting the evaluation values for the parameter values based on the evaluation values output at the evaluation unit and a combination of the parameter values, and determining, based on the trained model, a plurality of the parameter values to be next evaluated at the evaluation unit; and outputting, at an output unit, the parameter value optimized obtained by repeating processing at the evaluation unit and determination at the selection unit, in which the outputting at the evaluation unit includes, for each of the plurality of the parameter values determined at the selection unit, performing calculation based on the evaluation data and the parameter values and outputting the evaluation values, in parallel.

In order to achieve the object described above, a program of a seventh aspect of the present disclosure is a program causing a computer to perform an optimization processing, the optimization processing outputting an optimized parameter value, the optimized parameter value being obtained by repeating: performing calculation based on evaluation data and parameter values to be evaluated, and outputting evaluation values representing evaluation of calculation results; and training a model for predicting the evaluation values for the parameter values based on the output evaluation values and a combination of the parameter values, and determining, based on the trained model, a plurality of the parameter values to be evaluated, in which the outputting of the evaluation values includes, for each of the plurality of the parameter values determined, performing calculation based on the evaluation data and the parameter values and outputting the evaluation values, in parallel.

### Effects of the Invention

According to the present disclosure, an effect is obtained in which a plurality of parameter values can be simultaneously selected to achieve faster optimization of the parameters.

### BRIEF DESCRIPTION OF DRAWINGS

FIG. 1 is a block diagram illustrating a configuration of an example of an optimization apparatus according to an embodiment.

FIG. 2 is a diagram illustrating an example of a part of information stored in a parameter/evaluation value accumulation unit of the embodiment.

FIG. 3 is a schematic block diagram of an example of a computer that functions as the optimization apparatus.

FIG. 4 is a flowchart illustrating an example of an optimization processing routine in the optimization apparatus of the embodiment.

FIG. 5 is a diagram for describing a method of selecting a plurality of parameter values.

### DESCRIPTION OF EMBODIMENTS

Hereinafter, an embodiment of the present disclosure will be described in detail with reference to the drawings. As an example, in the present embodiment, a configuration will be described in which an optimization apparatus of the present disclosure is applied to an optimization apparatus that optimizes parameters of a guiding apparatus for guiding a pedestrian, based on evaluation values calculated from results of performing simulation of a pedestrian flow, a so-called human flow (hereinafter, referred to as “human flow simulation”).

In the example of the present disclosure, calculation corresponds to performing the human flow simulation, and a parameter x corresponds to a method of determining how to perform guidance. It is assumed that the parameter x is a multi-element (multidimensional) parameter and the number of elements is D. That is, x=(x₁, . . . , x_{D}) is satisfied and x₁, x₂, . . . are a first element, a second element, . . . of the parameter, respectively. Here, when t denotes the number of times of repetitions, and k denotes the order of a parameter when selected parameters in the t-th operation are arranged in order from 1, a parameter value is represented as x_{t,k}. It is also assumed that K is the number of parameter values selected in a single operation.

### Configuration of Optimization Apparatus in Present Embodiment

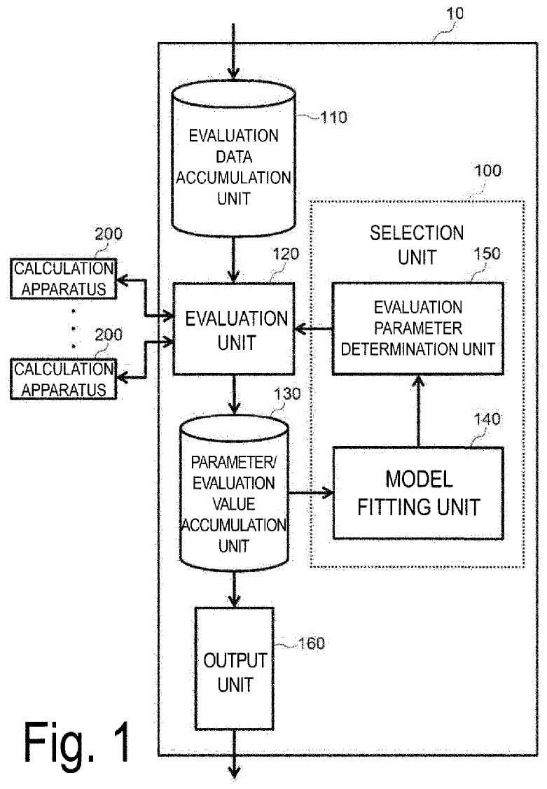

FIG. 1 is a block diagram illustrating a configuration of an example of an optimization apparatus according to the present embodiment.

As an example, an optimization apparatus 10 of the present embodiment can be constituted by a computer including a central processing unit (CPU), a random access memory (RAM), and a read only memory (ROM) storing a program for executing an optimization processing routine to be described later and various data. Specifically, the CPU executing the program described above functions as a selection unit 100, an evaluation unit 120, and an output unit 160 of the optimization apparatus 10 illustrated in FIG. 1.

As illustrated in FIG. 1, the optimization apparatus 10 of the present embodiment includes the selection unit 100, an evaluation data accumulation unit 110, the evaluation unit 120, a parameter/evaluation value accumulation unit 130, and the output unit 160.

The evaluation data accumulation unit 110 stores evaluation data necessary for the evaluation unit 120 to perform a human flow simulation. The evaluation data is data required to calculate pedestrian conditions for performing guidance, and includes, but is not limited to, a shape of a road, a pace of a pedestrian, the number of pedestrians, a time of entry of each pedestrian into a simulation section, routes of pedestrians, and start time and end time of the human flow simulation. The evaluation data is input to the evaluation data accumulation unit 110 from the outside of the optimization apparatus 10 at any timing, and output to the evaluation unit 120 in accordance with an instruction from the evaluation unit 120.

The evaluation unit 120 performs the human flow simulation based on the parameter values x_{t, k} (k=1, 2, . . . , K) to be evaluated and the evaluation data obtained from the evaluation data accumulation unit 110, and derives an evaluation value y_{t, k} for each of the parameter values x_{t, k} to be evaluated.

In the present embodiment, as an example, the evaluation value y, which is a result of the human flow simulation, is the time required for a pedestrian to reach a destination.

Specifically, the evaluation data acquired from the evaluation data accumulation unit 110 is input to the evaluation unit 120.

In addition, K parameter values x_{t, k} (k=1, 2, . . . , K) in the next human flow simulation are input to the evaluation unit 120 from the selection unit 100. In other words, when the number of human flow simulations is t, K parameter values x_{t, k} (k=1, 2, . . . , K) of the t+1-th human flow simulation are input to the evaluation unit 120 from the selection unit 100.

The evaluation unit 120 uses a plurality of calculation apparatuses 200 to perform the human flow simulation based on the parameter values x_{t, k} (k=1, 2, . . . , K) to be evaluated and the evaluation data obtained from the evaluation data accumulation unit 110 in parallel, and derives the evaluation value y_{t, k} for each of the parameter values x_{t, k} to be evaluated. Here, the plurality of calculation apparatuses 200 may be one apparatus provided with a plurality of CPUs or GPUs capable of parallel processing.

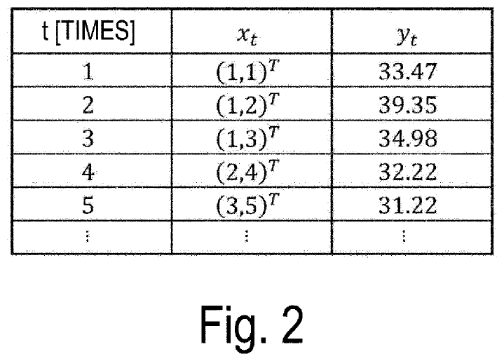

The parameter/evaluation value accumulation unit 130 stores data of the human flow simulation previously performed by the evaluation unit 120, input from the evaluation unit 120. Specifically, the data stored by the parameter/evaluation value accumulation unit 130 is the k-th parameter value x_{t, k} selected at the t-th time (t=0, 1, 2, . . . ), and the k-th evaluation value y_{t, k} of the t-th time. A combined set of a set of x_{t, k} in t=1, 2, . . . and k=1, 2, . . . K, and and a set of x_{t, k} in t=0 and k=1, 2, . . . , n is denoted as X. A combined set of a set of y_{t, k} in t=1, 2, . . . and k=1, 2, . . . K and a set of y_{t, k} in t=0 and k=1, 2, . . . , n is denoted as Y. FIG. 2 illustrates an example of a part of information stored in the parameter/evaluation value accumulation unit 130.

The selection unit 100 trains a model for predicting an evaluation value based on the evaluation value y_{t, k} output by the evaluation unit 120 and a combination of the parameter values x_{t, k}, and determines a plurality of parameter values to be next evaluated by the evaluation unit 120 based on the trained model.

Specifically, the selection unit 100 includes a model fitting unit 140 and an evaluation parameter determination unit 150.

The model fitting unit 140 trains a model for predicting an evaluation value from X and Y or a part of X and Y received from the parameter/evaluation value accumulation unit 130, and outputs the trained model to the evaluation parameter determination unit 150.

The evaluation parameter determination unit 150 uses an acquisition function, which is a function using an average and a variance of predicted values of the evaluation values obtained from the model received from the model fitting unit 140, uses a parameter value determined by a prescribed method as an initial value, and, using a gradient method, repeats obtaining a parameter value which takes a local maximum value of the acquisition function a plurality of times. Then, the evaluation parameter determination unit 150 selects parameter values x_{t, k} (k=1, 2, . . . , K) to be next evaluated by selecting, among parameter values that takes a local maximum value of the acquisition function, a plurality of parameter values that have a large value of the acquisition function and outputs the selected parameter values to the evaluation unit 120.

The output unit 160 outputs the optimized parameter values obtained by repeating processing by the evaluation unit 120 and determination by the selection unit 100. An example of an output destination is a pedestrian guiding apparatus.

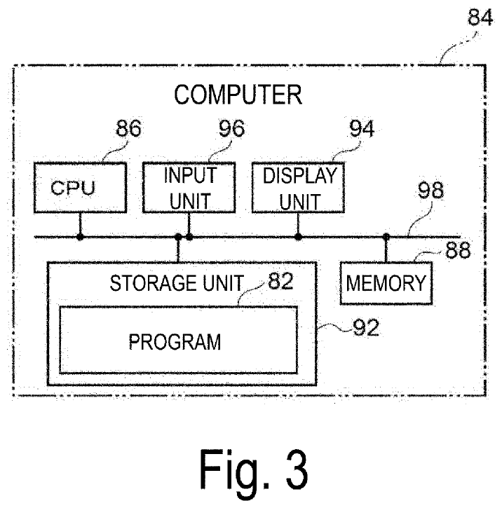

The optimization apparatus 10 is implemented by a computer 84 illustrated in FIG. 3, as an example. The computer 84 includes a central processing unit (CPU) 86, a memory 88, a storage unit 92 storing a program 82, a display unit 94 including a monitor, and an input unit 96 including a keyboard and a mouse. The CPU 86 is an example of a processor that is hardware. The CPU 86, the memory 88, the storage unit 92, the display unit 94, and the input unit 96 are connected to each other via a bus 98.

The storage unit 92 is implemented by a hard disk drive (HDD), a solid state drive (SSD), a flash memory, or the like. The storage unit 92 stores the program 82 for causing the computer 84 to function as the optimization apparatus 10. The storage unit 92 also stores data input by the input unit 96, intermediate data during execution of the program 82, and the like. The CPU 86 reads out the program 82 from the storage unit 92 and expands it into the memory 88 to execute the program 82. Note that the program 82 may be stored in a computer readable medium and provided.

### Effect of Optimization Apparatus of Present Embodiment

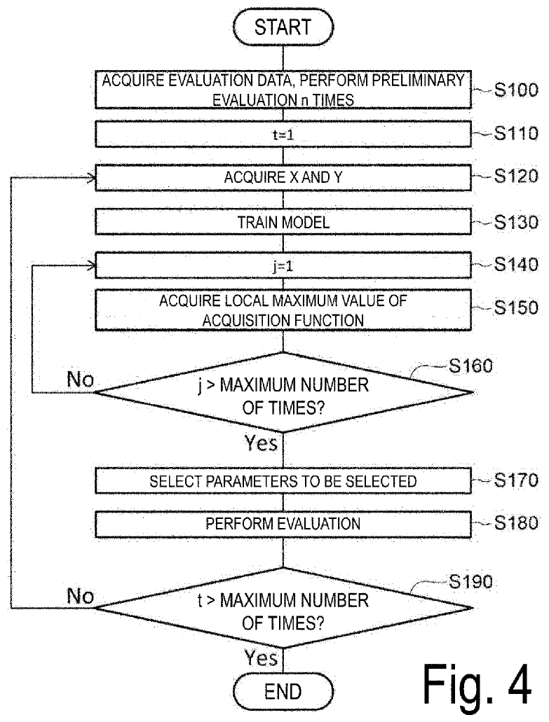

An effect of the optimization apparatus 10 of the present embodiment will be next described with reference to the drawings. FIG. 4 is a flowchart illustrating an example of an optimization processing routine executed in the optimization apparatus of the present embodiment.

The optimization processing routine illustrated in FIG. 4 is executed at any timing such as a timing when the evaluation data is stored in the evaluation data accumulation unit 110, or a timing when an execution instruction of the optimization processing routine is received from the outside of the optimization apparatus 10. Note that in the optimization apparatus 10 of the present embodiment, the evaluation data required to perform the human flow simulation is stored in advance in the evaluation data accumulation unit 110 before performing the optimization processing routine.

In step S100 of FIG. 4, the evaluation unit 120 acquires the evaluation data required for the human flow simulation from the parameter/evaluation value accumulation unit 130. In addition, the evaluation unit 120 performs preliminary evaluation n times using the plurality of calculation apparatuses 200 to generate data for training a model described later, thereby obtaining the parameter value x_{0, k}, and the evaluation value y_{0, k}. Here, k=1. 2 . . . n is satisfied. The value of n is arbitrary. Furthermore, how to set a parameter to be preliminarily evaluated is arbitrary. For example, there are methods such as a method of selecting a parameter by random sampling or a method of manually selecting a parameter.

In step S110, the selection unit 100 sets the number of times of repetitions t=1. An embodiment when the number of times of repetitions is the t-th time will be described below.

In step S120, the model fitting unit 140 acquires the data set X of parameters and the data set Y of evaluation values in the past repetitions from the parameter/evaluation value accumulation unit 130.

In step S130, the model fitting unit 140 builds a model from the data sets X and Y. An example of a model is a probability model using a Gaussian process. When Gaussian process regression is used, an unknown index y can be inferred as a probability distribution in the form of a normal distribution for any input x. That is, an average μ(x) of predicted values of the evaluation values and a variance of the predicted values (which represents a certainty factor with respect to the predicted values) σ(x) can be obtained. The Gaussian process uses a function called a kernel that represents a relationship among a plurality of points. Any kernel may be used. As an example, there is a Gaussian kernel represented by Equation (1).

$$[ Math . 1 ]$$

$$k ( {x}_{1} , {x}_{2} ) = {e}^{- {\vert {x}_{1} - {x}_{2} \vert}^{2} \text{/} θ} \qquad ( 1 )$$

Here, θ is a hyperparameter that takes a real number greater than 0. As an example of θ, a value point-estimated to have the maximum marginal likelihood of the Gaussian process is used.

In step S140 to step S160, the evaluation parameter determination unit 150 selects the parameter values x_{t, k} (k=1, 2, . . . , K) to be evaluated. At this time, the received model is used to obtain a predicted value of the evaluation value of the parameter, and an extent to which the parameter should be actually evaluated is quantified. The function used for the quantification is referred to as an acquisition function α(x). As an example of the acquisition function, there is an upper confidence bound represented by Equation (2). Here, μ(x) and σ(x) are the average and variance predicted by the model, respectively, β(t) is the parameter, and β(t)=log t is satisfied as an example.

[Math. 2]

α(x)=μ(x)+\sqrt{β(t)}σ(x) (2)

The above equation represents a case where maximization is performed, and when minimization is performed, μt(x) is replaced with −μ(x).

A process of selecting a parameter is as follows. First, in step S140, the evaluation parameter determination unit 150 sets j=1.

Then, in step S150, the evaluation parameter determination unit 150 sets an appropriate parameter xⱼ as an initial value. The method of setting xⱼ may be random sampling or the like, but any method may be used. Then, the evaluation parameter determination unit 150 uses xⱼ as an initial value of an input, and using a gradient method (e.g., L-BFGS-B), obtains a local maximum value x_{j, m} of the acquisition function α(x). At this time, in a case where a technique 1 described later is adopted, optimization is performed for all elements of the parameter x by the gradient method. On the other hand, in a case where a technique 2 described later is adopted, only some of elements of the parameter (for example, only the first and second elements are selected when D=3 is satisfied) are selected, and only the elements are optimized to obtain a local maximum value of the acquisition function for some dimensions as x_{j, m}.

Thereafter, the evaluation parameter determination unit 150 sets j=j+1.

In step S160, the evaluation parameter determination unit 150 determines whether j exceeds the maximum number of times J. If j exceeds the maximum number of times J, the evaluation parameter determination unit 150 shifts to step S170, and otherwise the evaluation parameter determination unit 150 returns to step S150. Thus, the processing of step S150 is performed a plurality of times. Here, a local maximum value is not necessarily the maximum value because the acquisition function α(x) is generally a multimodal, non-convex function. Thus, depending on the set value xⱼ, the resulting x_{j, m} may be different. In addition, when the technique 2 is adopted and only some elements are selected to perform optimization using the gradient method, the resulting x_{j, m} differs depending on the selected elements.

In step S170, the evaluation parameter determination unit 150 determines x_{t, k} in k=1, 2, . . . , K using x_{j, m} in j=1, . . . , J. For this, there are two techniques, that is, the technique 1 being basic and the technique 2 being derivative.

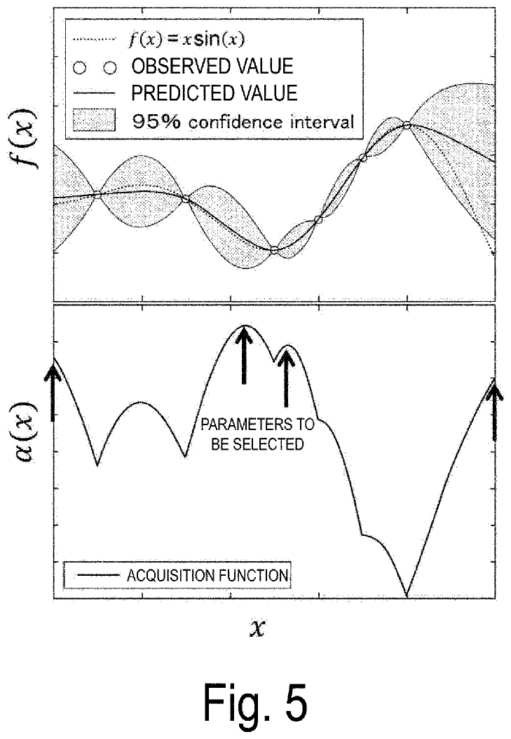

The technique 1 will be first described. First, depending on xⱼ, x_{j, m} may represent a same parameter for a plurality of j, which is deemed to be overlapping, and a set in which parameter values are excluded such that the overlap is eliminated is obtained as a set Xₘ of parameter values. The elements of the set Xₘ of parameter values obtained in this state all represent different parameter values. Then, a value of the acquisition function of a parameter value x_{j, m} that is an element of Xₘ is calculated, K values are selected in descending order of the values of the acquisition function, and the K values are defined as the parameter values x_{t, k} in k=1, 2, . . . , K. An example of parameter values selected (when four parameter values are selected) is illustrated in FIG. 5.

As illustrated in FIG. 5, the acquisition function is a multi-modal function and has local maximum values in addition to the maximum value. These are parameters to be examined preferentially next to the maximum value. In the present embodiment, a plurality of the local maximum values are selected in descending order of the values of the acquisition function, so that a plurality of parameter values can be selected.

Next, the technique 2 will be described. This is a method that can be applied to a case where only some elements of parameters are optimized in the gradient method in step S150. It is the same as the technique 1 to first exclude the overlap of x_{j, m}. Next, only some elements optimized when obtaining x_{j, m} are taken out from x_{j, m}. Then, only optimized elements are similarly taken out from other x_{j, m} that are obtained by optimizing some other elements different from the some elements and the taken elements are combined to obtain new parameter values. This operation is done for all possible combinations of elements, and the resulting set of parameter values is defined as Xₘ.

Specifically, as high dimensional Bayesian optimization, a technique is used in which optimization is performed assuming that a high dimensional function f is a sum of low dimensional functions f⁽¹⁾, . . . , f^{(M)}, as shown in the following equation.

f(x)=f¹⁾(x⁽¹⁾)+f⁽²⁾(x⁽²⁾)+ . . . +f^{(M)}(x^{(M)}). [Math. 3]

At this time, when for each of the acquisition functions for low dimensional functions f⁽¹⁾, . . . , f^{(M)}, k local maximum values of the acquisition function are taken, the M-th power of k types of combinations of parameter values are obtained. Among these combinations, a plurality of parameter values are selected in descending order of values of the acquisition function of the high dimensional function f

For example, consider a case where when J=4 and D=2 are satisfied, in j=1, 2, only the first element of xⱼ is optimized using the gradient method to obtain x_{j, m}, and in j=3, 4, only the second element of xⱼ is optimized using the gradient method to obtain x_{j, m}. At this time, x_{1, m, 1} and x_{2, m, 1} which are obtained by taking out only the first elements of x_{1, m} and x_{2, m} are taken out, and x_{3, m, 2} and x_{4, m, 2} which are obtained by taking out only the second elements of x_{3, m} and x_{4, m} are taken out. As combinations of these, four combinations are possible. In other words, there are a combination of x_{1, m, 1} and x_{3, m, 2}, a combination of x_{2, m, 1} and x_{3, m, 2}, a combination of x_{1, m, 1} and x_{3, m, 2}, and a combination of x_{2, m, 1} and x_{4, m, 2}. Thus, Xₘ−{(x_{1, m, 1}, x_{3, m, 2}), (x_{2, m, 1}, x_{3, m, 2}), (x_{1, m, 1}, x_{4, m, 2}), (x_{2, m, 1}, x_{4, m, 2})} is satisfied. Thereafter, the parameter values xₜ in k=1, 2, . . . , K are selected in descending order of values of the acquisition function for all elements using the set Xₘ in the same manner as the technique 1.

In step S180, the evaluation unit 120 performs evaluation in parallel by the plurality of calculation apparatuses 200 using the data necessary to perform evaluation transmitted from the evaluation data accumulation unit 110 and the parameters xₜ in k=1, 2, . . . , K transmitted from the evaluation parameter determination unit 150 to obtain evaluation values y_{t, k} (k=1, 2, . . . , K). Then, the evaluation unit 120 stores the parameters x_{t, k} and the evaluation values y_{t,k} in the parameter/evaluation value accumulation unit 130. At this time, the plurality of calculation apparatuses 200 for performing evaluation are used to acquire the evaluation values y_{t, k} simultaneously for a plurality of k using parallel processing.

In step S190, the output unit 160 determines whether the number of times of repetitions exceeds the prescribed maximum number, and when the number of times does not exceed the maximum number, returns to step S120, and when the number of times exceeds the maximum number, terminates the present optimization processing routine. An example of the maximum number of times of repetitions is 1000 times. At the end of the present optimization processing routine, the output unit 160 outputs a parameter value having the best evaluation value.

As described above, the optimization apparatus 10 of the present embodiment includes the evaluation unit 120, the selection unit 100, and the output unit 160. The evaluation unit 120 performs calculation based on evaluation data and parameter values to be evaluated, and outputs evaluation values representing the evaluation of the calculation results. The selection unit 100 trains a model for predicting an evaluation value for a parameter value based on the evaluation values output by the evaluation unit 120 and a combination of the parameter values, and determines, based on the trained model, a plurality of parameter values to be next evaluated by the evaluation unit 120. The output unit 160 outputs an optimized parameter value obtained by repeating processing by the evaluation unit 120 and determination by the selection unit 100. The evaluation unit 120 of the optimization apparatus 10 performs calculation based on the evaluation data and the parameter values and outputs the evaluation values, in parallel, for each of the plurality of parameter values determined by the selection unit 100.

In the optimization apparatus 10 of the present embodiment, the plurality of parameter values are selected in a single operation, and the selected values are evaluated by parallel processing to perform optimization with a small number of repetitions. In this way, according to the optimization apparatus 10 of the present embodiment, a plurality of parameter values can be simultaneously selected, whereby parameters can be optimized at high speed.

Note that the present disclosure is not limited to the above embodiment and various modifications and applications are possible without departing from the gist of the present disclosure.

In the above-described embodiment, a configuration has been described in which the optimization apparatus 10 is applied to the human flow simulation using the parameter x as a way of guidance, but the present disclosure is not limited thereto.

For example, as another embodiment, the optimization apparatus 10 can be applied to traffic simulation using the parameter x as a timing for switching a traffic signal, the evaluation value y as an arrival time to a destination, and the like. Alternatively, for example, as another embodiment, the optimization apparatus 10 can be applied to machine learning using the parameter x as a hyperparameter of an algorithm, the evaluation value y as an accuracy rate of inference, and the like.

In addition, although in the present embodiment, a form in which the program is installed in advance has been described, the program can also be stored and provided in a computer-readable recording medium or can be provided via a network.

### REFERENCE SIGNS LIST

10 Optimization apparatus
100 Selection unit
110 Evaluation data accumulation unit
120 Evaluation unit
130 Parameter/evaluation value accumulation unit
140 Model fitting unit
150 Evaluation parameter determination unit
160 Output unit
200 Calculation apparatus

1. An optimization apparatus, comprising:
an evaluator configured to determine, based on evaluation data and parameter values to be evaluated, evaluation values representing evaluation results;
a selector configured to train a model for predicting the evaluation values for the parameter values based on the evaluation values and a combination of the parameter values and determine, based on the trained model, a plurality of the parameter values to be next evaluated by the evaluator; and
an output provider configured to output the parameter value optimized obtained by repeating processing by the evaluator and determination by the selector, wherein
for each of the plurality of the parameter values determined at the selector, the evaluator determines the evaluation values based on the evaluation data and the parameter values and outputs the evaluation values, in parallel.

2. The optimization apparatus according to claim 1, wherein the selector:
trains the model based on the evaluation values and a combination of the parameter values;
using an acquisition function, with a parameter value determined by a prescribed method as an initial value, repeats obtaining a parameter value that takes a local maximum value of the acquisition function using a gradient method a plurality of times, the acquisition function being a function using an average and a variance of predicted values of the evaluation values obtained from the trained model; and
selects a plurality of parameter values having a large value of the acquisition function among parameter values that take a local maximum value of the acquisition function to determine a plurality of the parameter values to be next evaluated by the evaluator.

3. The optimization apparatus according to claim 2, wherein
the parameter comprises a plurality of elements, and
the selector:
trains the model for a part of the elements, and using the acquisition function obtained from the model, repeats obtaining values of the part of the elements that take a local maximum value of the acquisition function a plurality of times;
trains the model for another part of the elements, and using the acquisition function obtained from the model, repeats obtaining values of the other part of the elements that take a local maximum value of the acquisition function a plurality of times; and
from the parameter values obtained by combining values of the part of the elements obtained a plurality of times and values of the other part of the elements obtained a plurality of times, determines a plurality of the parameter values to be next evaluated at the evaluator.

4. The optimization apparatus according to claim 1, wherein the evaluator determines evaluation values using at least one calculation apparatus and outputs evaluation values representing evaluation results, in parallel.

5. The optimization apparatus according to claim 1, wherein the model is a probability model using a Gaussian process.

6. An optimization method comprising:
performing, by an evaluator, determination based on evaluation data and parameter values to be evaluated, and outputting evaluation values representing evaluation of determination results;
training, by a selector, a model for predicting the evaluation values for the parameter values based on the evaluation values output at the evaluator and a combination of the parameter values, and determining, based on the trained model, a plurality of the parameter values to be next evaluated at the evaluation unit; and
outputting, by an output provider, the parameter value optimized obtained by repeating processing by the evaluator and determination by the selector, wherein
the outputting by the evaluator includes, for each of the plurality of the parameter values determined by the selector, performing determination performed based on the evaluation data and outputting the parameter values and the evaluation values, in parallel.

7. A computer-readable non-transitory recording medium storing computer-executable program instructions that when executed by a processor cause a computer system to perform an optimization processing, the optimization processing outputting an optimized parameter value, the optimized parameter value being obtained by repeating:
determining, by an evaluator, based on evaluation data and parameter values to be evaluated, and outputting evaluation values representing evaluation of determination results; and
training, by a selector, a model for predicting the evaluation values for the parameter values based on the output evaluation values and a combination of the parameter values, and determining, based on the trained model, a plurality of the parameter values to be evaluated, wherein
the outputting of the evaluation values includes, for each of the plurality of the parameter values determined, performing determination based on the evaluation data and the parameter values and outputting the evaluation values, in parallel.

8. The optimization apparatus according to claim 2, wherein the evaluator determines evaluation values using at least one calculation apparatus and outputs evaluation values representing evaluation results, in parallel.

9. The optimization apparatus according to claim 2, wherein the model is a probability model using a Gaussian process.

10. The optimization method according to claim 6, wherein the selector:
trains the model based on the evaluation values and a combination of the parameter values;
using an acquisition function, with a parameter value determined by a prescribed method as an initial value, repeats obtaining a parameter value that takes a local maximum value of the acquisition function using a gradient method a plurality of times, the acquisition function being a function using an average and a variance of predicted values of the evaluation values obtained from the trained model; and
selects a plurality of parameter values having a large value of the acquisition function among parameter values that take a local maximum value of the acquisition function to determine a plurality of the parameter values to be next evaluated by the evaluator.

11. The optimization method according to claim 6, wherein the evaluator determines evaluation values using at least one calculation apparatus and outputs evaluation values representing evaluation results, in parallel.

12. The optimization method according to claim 6, wherein the model is a probability model using a Gaussian process.

13. The computer-readable non-transitory recording medium according to claim 7, wherein the selector:
trains the model based on the evaluation values and a combination of the parameter values;
using an acquisition function, with a parameter value determined by a prescribed method as an initial value, repeats obtaining a parameter value that takes a local maximum value of the acquisition function using a gradient method a plurality of times, the acquisition function being a function using an average and a variance of predicted values of the evaluation values obtained from the trained model; and
selects a plurality of parameter values having a large value of the acquisition function among parameter values that take a local maximum value of the acquisition function to determine a plurality of the parameter values to be next evaluated by the evaluator.

14. The computer-readable non-transitory recording medium according to claim 7, wherein the evaluator determines evaluation values using at least one calculation apparatus and outputs evaluation values representing evaluation results, in parallel.

15. The computer-readable non-transitory recording medium according to claim 7, wherein the model is a probability model using a Gaussian process.

16. The optimization method according to claim 10, wherein
the parameter comprises a plurality of elements, and
the selector:
trains the model for a part of the elements, and using the acquisition function obtained from the model, repeats obtaining values of the part of the elements that take a local maximum value of the acquisition function a plurality of times;
trains the model for another part of the elements, and using the acquisition function obtained from the model, repeats obtaining values of the other part of the elements that take a local maximum value of the acquisition function a plurality of times; and
from the parameter values obtained by combining values of the part of the elements obtained a plurality of times and values of the other part of the elements obtained a plurality of times, determines a plurality of the parameter values to be next evaluated at the evaluator.

17. The optimization method according to claim 10, wherein the evaluator determines evaluation values using at least one calculation apparatus and outputs evaluation values representing evaluation results, in parallel.

18. The optimization method according to claim 10, wherein the model is a probability model using a Gaussian process.

19. The computer-readable non-transitory recording medium according to claim 13, wherein the evaluator determines evaluation values using at least one calculation apparatus and outputs evaluation values representing evaluation results, in parallel.

20. The computer-readable non-transitory recording medium according to claim 13, wherein the model is a probability model using a Gaussian process.
